(19) United States
(12) Patent Application Publication
(10) Pub. No.: US 2005/0171638 A1
(43) Pub. Date: Aug. 4, 2005

(54) Self-traveling vacuum cleaner capable of ensuring wide obstacle detection range

(75) Inventors: Naoya Uehigashi, Daito-shi (JP); Ryo Saeki, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/045,746

(22) Filed: Jan. 28, 2005

(30) Foreign Application Priority Data
Jan. 30, 2004 (JP) JP2004-024277

(51) Int. Cl. G05D 1/00

(52) U.S. Cl. 700/245; 701/23

(57) ABSTRACT

A passive sensor is provided in a forward direction of a main body of a self-traveling vacuum cleaner. The passive sensor receives a reflected light of an external light of a target object at a length within a certain length range at a predetermined angle of visibility, and measures the length to a target object based on a phase difference of the received reflected light of the target object. The passive sensor includes a predetermined detectable length, and also includes an obstacle detection range of a predetermined area relative to the forward direction. The passive sensor has a long detectable length and an extremely wide angle of visibility, as compared with an active sensor. It is, therefore, possible to ensure a wider obstacle detection range than the active sensor, using the single passive sensor.

### BACKGROUND OF THE INVENTION

1. Field of the Invention

The present invention relates to a self-traveling vacuum cleaner having a self-traveling function and automatically cleaning a cleaning target surface.

2. Description of the Background Art

Vacuum cleaners intended to improve cleaning operability by adding a moving function have been conventionally developed. Recently, attention has been paid particularly to development of a so-called autonomous induction type self-traveling vacuum cleaner having various sensors such as a microcomputer mounted therein. The self-traveling vacuum cleaner (hereinafter, also referred to as simply “vacuum cleaner”) of this type starts making a motion by wheels driven by a drive motor when being activated. During the motion, the vacuum cleaner measures a length to an obstacle such as furniture using a plurality of sensors or the like, detects a stepped portion of a cleaning target surface, moves while avoiding the obstacle and the stepped portion, absorbs dusts adhering on the cleaning target surface using a suction port, a brush, and the like provided on a bottom of a cleaner main body, and thereby automatically cleans the cleaning target surface.

For example, Japanese Laying-Open Patent Publication Nos. 05-084200 and 2003-116758 disclose self-traveling vacuum cleaners each of which detects a stepped state on a cleaning target surface by measuring a length based on sensors, prevents falling from stairs or the like, and performs a safe cleaning operation.

Meanwhile, a conventional sensor is an infrared sensor or an ultrasonic sensor that is an active sensor. The sensor outputs an infrared ray or an ultrasonic wave from the main body, and measures a length to a target object based on a reflected ray or reflected wave of the infrared ray or the ultrasonic wave. The infrared sensor or the ultrasonic sensor is characterized in that it has directivity and can detect angles only in a present range. Namely, an obstacle detection range of one sensor is restricted to an extremely small range.

To obtain a wider obstacle detection range, therefore, it is disadvantageously necessary to increase the number of sensors, resulting in cost increase and deterioration in installation efficiency.

### SUMMARY OF THE INVENTION

The present invention has been achieved to solve the conventional disadvantages. It is an object of the present invention to provide a self-traveling vacuum cleaner capable of ensuring a wider obstacle detection range by a simple constitution.

According to one aspect of the present invention, there is provided a self-traveling vacuum cleaner including: a driving unit that moves a main body relative to a desired direction; a sensor that receives a reflected light of a target object at a length within a certain length range at a predetermined angle of visibility, and that measures the length to the target object based on a phase difference of the received reflected light of the target object; and a controller that calculates the length to the target object and that controls the driving unit based on a measurement result of the sensor, wherein the sensor includes a first cell region and a second cell region for measuring a quantity of the received reflected light, the controller calculates the length to the target object based on a relative difference of a measurement result obtained in the first cell region to a measurement result obtained in the second cell region, the sensor is arranged to measure the target object in a lateral direction of a surface perpendicular to a forward direction, at the predetermined angle of visibility, an obstacle detection range having the predetermined angle of visibility of the sensor is divided into a plurality of regions along the lateral direction, the controller measures the length to the target object in each of the divided regions, and indicates the driving unit to stop the self-traveling vacuum cleaner if the length to the target object is equal to or smaller than a predetermined length in all of the divided regions of the obstacle detection range of the sensor, and the sensor includes a plurality of CCD elements arranged on a line.

According to another aspect of the present invention, there is provided a self-traveling vacuum cleaner including: a driving unit that moves a main body relative to a desired direction; a sensor that receives a reflected light of a target object at a length within a certain length range at a predetermined angle of visibility, and that measures the length to the target object based on a phase difference of the received reflected light of the target object; and a controller that calculates the length to the target object and that controls the driving unit based on a measurement result of the sensor.

Preferably, the sensor includes a first cell region and a second cell region for measuring a quantity of the received reflected light, and the controller calculates the length to the target object based on a relative difference of a measurement result obtained in the first cell region to a measurement result obtained in the second cell region.

Preferably, the sensor is arranged to measure the target object in a lateral direction of a surface perpendicular to a forward direction, at the predetermined angle of visibility, an obstacle detection range having the predetermined angle of visibility of the sensor is divided into a plurality of regions along the lateral direction, and the controller measures the length to the target object in each of the plurality of regions, and indicates the driving unit to stop the self-traveling vacuum cleaner if the length to the target object is equal to or smaller than a predetermined length in all of the plurality of regions of the obstacle detection range of the sensor.

Preferably, the sensor is arranged to measure the target object in a lateral direction of a surface perpendicular to a forward direction, at the predetermined angle of visibility, an obstacle detection range having the predetermined angle of visibility of the sensor is divided into a plurality of regions along the lateral direction, and the controller measures the length to the target object in each of the plurality of regions, indicates, if the length to the target object is equal to or smaller than a predetermined length in the plurality of regions on both ends of the obstacle detection range of the sensor, respectively, the driving unit to stop the self-traveling vacuum cleaner, and indicates, if the length to the target object is equal to or smaller than the predetermined length in at least one of the regions on the both ends of the obstacle detection range, the driving unit to start an avoidance motion of avoiding toward the other region out of the regions on the both ends of the obstacle detection range.

Preferably, the sensor includes a plurality of CCD elements arranged on a line.

Preferably, the sensor is arranged to measure the target object in a lateral direction of a surface perpendicular to a forward direction, at the predetermined angle of visibility, an obstacle detection range having the predetermined angle of visibility of the sensor is divided into a first region in a direction of a forward region of the main body and a second region outward of the forward region of the main body, and the controller measures the length to the target object in the second region, and indicates the driving unit to stop the self-traveling vacuum cleaner if the length to the target object in the second region is changed in a predetermined period.

Preferably, the controller measures the length to the target object in the first region, and indicates the driving unit to stop the self-traveling vacuum cleaner if the length to the target object in the first region is equal to or smaller than a predetermined length.

Preferably, the sensor is arranged to measure a length to a cleaning target surface in a region in a forward direction, and the controller measures the length to the cleaning target surface in the region in the forward direction, and indicates the driving unit to stop the self-traveling vacuum cleaner if the length to the cleaning target surface is changed from the certain length.

In particular, the controller determines that a stepped portion is present if the length to the target object is larger than the certain length.

In particular, the controller determines that an obstacle is present if the length to the target object is smaller than the certain length.

Preferably, the sensor is arranged to measure a cleaning target surface in a direction of a forward region of the main body and the target object outward of the forward region of the main body, at the predetermined angle of visibility, an obstacle detection range having the predetermined angle of visibility of the sensor is divided into a first region inward of the forward region of the main body and a second region outward of the forward region of the main body, and the controller measures the length to the target object in the second region, and indicates the driving unit to stop the self-traveling vacuum cleaner if the length to the target object in the second region is changed in a predetermined period and is smaller than the certain length.

In particular, the controller measures a length to the cleaning target surface in the first region, and indicates the driving unit to stop the self-traveling vacuum cleaner if the length to the cleaning target surface in the first region is changed.

In particular, the sensor is provided on one end of the main body in a lateral direction of the main body, has a predetermined depression angle with respect to a horizontal level in the forward direction, and is arranged laterally to be shifted by a predetermined angle from the horizontal level in the forward direction so as to face the other end of the main body in the forward direction.

Preferably, the sensor is arranged to measure the target object in a direction of height of a surface perpendicular to a forward direction, at the predetermined angle of visibility, an obstacle detection range having the predetermined angle of visibility of the sensor is divided into a first region for detecting an upper region than a maximum height of the main body in the direction of height and a second region for detecting a lower region than the maximum height of the main body in the direction of height, and the controller measures the length to the target object in each of the first region and the second region, indicates the driving unit to stop the self-traveling vacuum cleaner if the length to the target object in the first region of the obstacle detection range of the sensor is equal to or smaller than a predetermined length and the length to the target object in the second region is equal to or smaller than the predetermined length, and fails to indicate the driving unit to stop the self-traveling vacuum cleaner if the length to the target object in the first region is equal to or smaller than the predetermined length and the length to the target object in the second region is not equal to or smaller than the predetermined length.

Preferably, the sensor is arranged aslant so as to measure the target object in each of a direction of height and a lateral direction of a surface perpendicular to a forward direction, at the predetermined angle of visibility, an obstacle detection range having the predetermined angle of visibility of the sensor is divided into a first region for detecting an upper region than a maximum height of the main body in the direction of height and a second region for detecting a lower region than the maximum height of the main body in the direction of height, and the controller measures the length to the target object in each of the first region and the second region, indicates the driving unit to stop the self-traveling vacuum cleaner if the length to the target object in the first region of the obstacle detection range of the sensor is equal to or smaller than the predetermined length and the length to the target object in the second region is equal to or smaller than the predetermined length, and fails to indicate the driving unit to stop the self-traveling vacuum cleaner if the length to the target object in the first region is equal to or smaller than the predetermined length and the length to the target object in the second region is not equal to or smaller than the predetermined length.

Preferably, the sensor is arranged to measure a cleaning target surface in a region in a forward direction of the main body and the target object in the forward direction, at the predetermined angle of visibility, an obstacle detection range having the predetermined angle of visibility of the sensor is divided into a first region in the forward direction of the main body and a second region in a direction of the cleaning target surface in the region of the main body in the forward direction, and the controller measures a length to the cleaning target surface in the second region, indicates the driving unit to stop the self-traveling vacuum cleaner if the length to the cleaning target surface in the second region is changed.

In particular, the controller measures the length to the target object in the forward direction in the first region, and indicates the driving unit to stop the self-traveling vacuum cleaner if the length to the cleaning target surface in the first region is equal to a smaller than a predetermined length.

The sensor of the self-traveling vacuum cleaner of the present application includes a sensor for measuring a length to a target object at a predetermined angle of visibility, and a controller that controls a driving unit based on a measurement result of the sensor. Namely, an obstacle or the like can be detected in a wide range using the single sensor having the predetermined angle of visibility, cost can be reduced, and installation efficiency can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a self-traveling vacuum cleaner according to a first embodiment of the present invention;

FIG. 2 is a conceptual view for describing a mechanism of the vacuum cleaner according to the first embodiment of the present invention;

FIG. 3 is a conceptual view for describing an obstacle detection range of a sensor according to the first embodiment of the present invention;

FIG. 4 is an illustration for measuring a length based on a detected phase difference;

FIG. 5 is an illustration for an output voltage of a sensor which voltage is subjected to A/D conversion by a CCD element that is a photoelectric conversion element in a sense region;

FIGS. 6A to 6C are illustrations for calculating the phase difference;

FIG. 7 is an illustration for a relationship between a correlation value and a shift amount described with reference to FIGS. 6A to 6C;

FIG. 8 is a conceptual view for describing an example of dividing an obstacle detection range into a plurality of sensor blocks according to the first embodiment of the present invention;

FIG. 9 is a flowchart for a processing performed by a controller for executing obstacle detection;

FIG. 10 is an illustration for an example in which the sensor reacts in all sensor blocks of the obstacle detection range;

FIG. 11 is an illustration for an example in which the sensor does not react in all sensor blocks of the obstacle detection range;

FIG. 12 is a schematic block diagram of a self-traveling vacuum cleaner according to a modification of the first embodiment of the present invention;

FIG. 13 is a conceptual view for describing an obstacle detection range of a sensor of the self-traveling vacuum cleaner according to the modification of the first embodiment of the present invention;

FIG. 14 is a flowchart for a processing performed by a controller for executing obstacle detection according to the modification of the first embodiment;

FIGS. 15A to 15C are conceptual views for describing an example of detecting a wall in a side surface direction using the flowchart of FIG. 14;

FIG. 16 is a schematic block diagram of a self-traveling vacuum cleaner according to a second embodiment of the present invention;

FIG. 17 is a flowchart for describing an obstacle detection method for detecting an obstacle such as a stepped portion according to the second embodiment of the present invention;

FIGS. 18A to 18C are illustrations for an example of detecting the obstacle such as the stepped portion based on the flowchart of FIG. 17;

FIG. 19 is a schematic block diagram of a self-traveling vacuum cleaner according to a third embodiment of the present invention;

FIG. 20 is a conceptual view for describing an obstacle detection range of a sensor shown in FIG. 19;

FIG. 21 is a flowchart for describing an obstacle detection method for detecting an obstacle in an upper region than a main body of the vacuum cleaner according to the third embodiment of the present invention;

FIGS. 22A to 22C are illustrations for an example in which the self-traveling vacuum cleaner according to the third embodiment of the present invention detects the obstacle in the upper region based on the flowchart of FIG. 21;

FIG. 23 is a schematic block diagram that illustrates another configuration of the self-traveling vacuum cleaner according to the third embodiment of the present invention;

FIG. 24 is a conceptual view for describing an obstacle detection range of a sensor described with reference to FIG. 23;

FIG. 25 is a schematic block diagram of a self-traveling vacuum cleaner according to a modification of the third embodiment of the present invention;

FIG. 26 is a conceptual view for describing an obstacle detection range according to the modification of the third embodiment of the present invention;

FIG. 27 is a schematic block diagram of a self-traveling vacuum cleaner according to a fourth embodiment of the present invention; and

FIG. 28 is a conceptual view for describing an obstacle detection range of a sensor shown in FIG. 27.

### DESCRIPTION OF THE PREFERRED EMBODIMENTS

Embodiments of the present invention will be described hereinafter in detail with reference to the drawings. In the drawings, same or corresponding constituent elements are denoted by the same reference symbols and will not be repeatedly described.

### First Embodiment

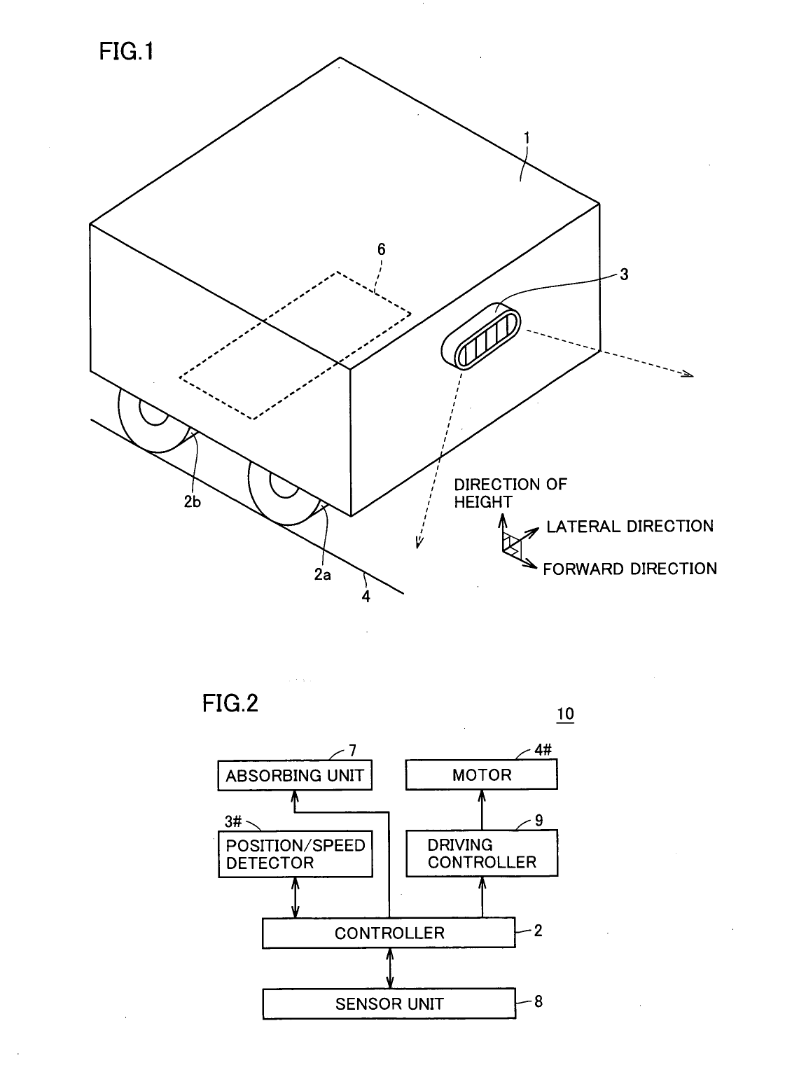

Referring to FIG. 1, a self-traveling vacuum cleaner (hereinafter, also referred to as simply “vacuum cleaner”) according to a first embodiment includes a main body 1, a passive sensor 3 provided on a front surface of main body 1, i.e., in a forward direction, wheels 2a and 2b, and a suction port 6. Passive sensor 3 is arranged laterally so as to measure a target object in a lateral direction of a surface perpendicular to the forward direction.

Passive sensor 3 receives a reflected light of an external light of the target object at a length within a certain length range at a predetermined angle of visibility, and measures a length to the target object based on a phase difference of the received reflected light of the target object. In the first embodiment, passive sensor 3 is a line sensor including a plurality of CCD elements (cells) which are provided linearly.

Referring to FIG. 2, main body 1 of the vacuum cleaner according to the first embodiment includes a controller 2 that controls an entirety of the vacuum cleaner, a position/speed detector 3# that detects a position and a forward speed of the vacuum cleaner, a motor 4# that drives wheels 2a and 2b, a driving controller 9 that controls a rotation speed and a forward direction of motor 4#, a sensor unit 8 that acquires a detection result of sensor 3 provided on the front surface of main body 1, i.e., in the forward direction of the vacuum cleaner, and an absorbing unit 7 that absorbs a dust and the like on a cleaning target surface from the suction port 6 in response to a command from controller 2. It is noted that wheels are similarly provided on a left side relative to the forward direction although they are not shown in the drawings.

Sensor unit 8 outputs the detection result acquired by sensor 3 to controller 2 in response to a command from controller 2. Position/speed detector 3# detects the position of the vacuum cleaner and the speed of the vacuum cleaner that performs a forward operation in response to a command from controller 2, and outputs the detected position and speed to controller 2. Driving controller 9 controls the rotation speed and forward direction of motor 4#, i.e., the direction of wheels 2a and 2b or the like in response to a command from controller 2.

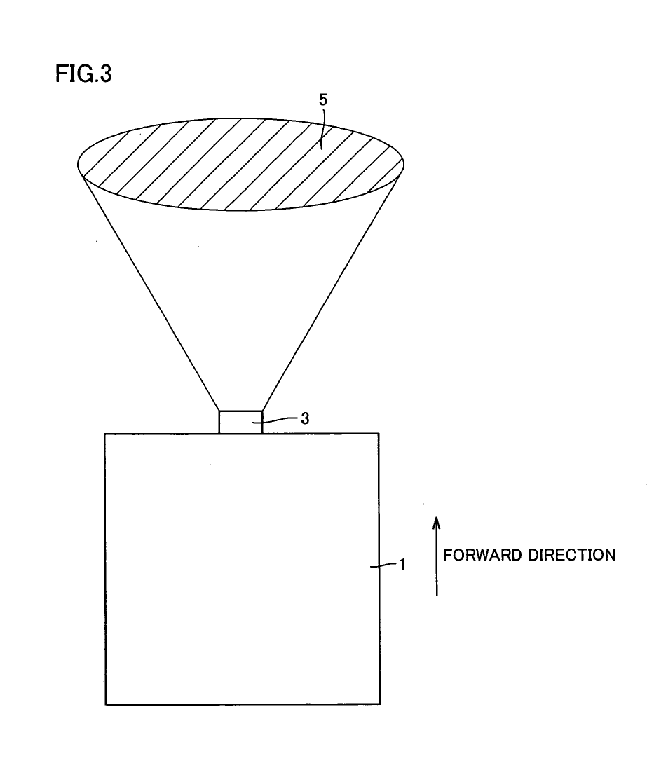

Referring to FIG. 3 that is a conceptual view for describing an obstacle detection range of sensor 3 according to the first embodiment of the present invention, sensor 3 has a predetermined detectable length and a predetermined angle of visibility. Namely, sensor 3 has an obstacle detection range 5 of a predetermined area relative to the forward direction. The passive sensor has a long detectable length and an extremely wide angle of visibility, as compared with the active sensor.

A length measurement method by detecting a phase difference based on sensor 3 according to this embodiment will first be described.

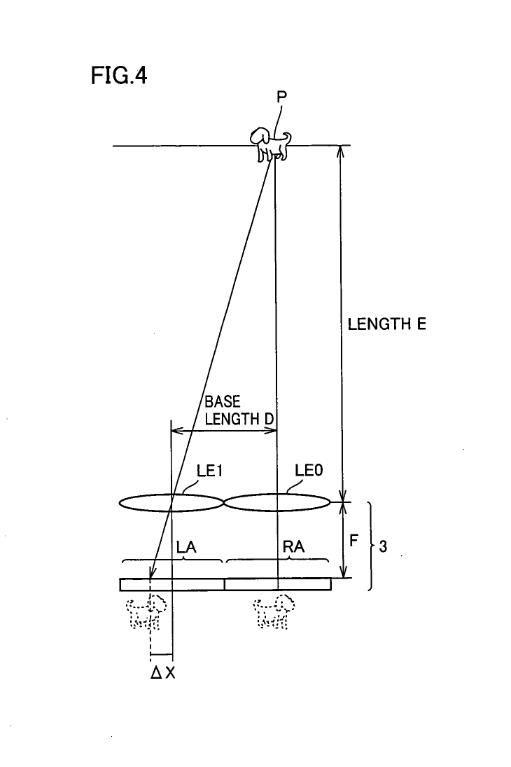

Referring to FIG. 4, the plural CCD elements (not shown) of sensor 3 are divided into two parts to provide sense regions RA and LA. Sensor 3 includes lenses LE0 and LE1 corresponding to respective sense regions RA and LA. Sensor 3 forms a subject image on the CCD elements that are the photoelectric conversion elements corresponding to sense region RA using lens LE0. Likewise, sensor 3 forms a subject image on the CCD elements that are the photoelectric conversion elements corresponding to sense region LA using lens LE1. The both subject images are formed at relatively shifted positions in sense regions RA and LA, respectively. Based on a relative difference (phase difference) ΔX between the image formation positions, a length to the subject is measured.

Specifically, a length E to a subject P is represented by the following equation according to triangulation.
E=D×F/ΔX

Herein, D denotes a base length and F denotes a focal length of the lens.

By measuring phase difference ΔX, length E to subject P can be calculated.

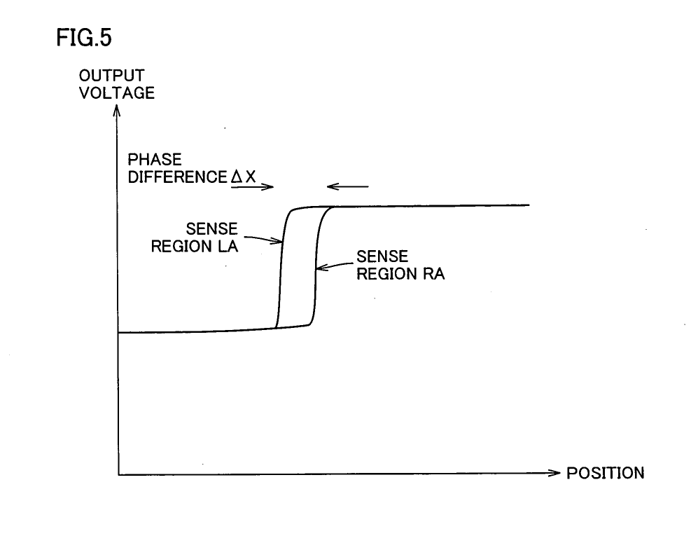

Referring to FIG. 5, output voltages of sensor 3 subjected to A/D conversion by the CCD elements that are photoelectric conversion elements in respective sense regions RA and LA will be described.

As shown in FIG. 5, there is a relative phase difference ΔX between an output voltage waveform based on the subject image in sense region RA and that in sense region LA.

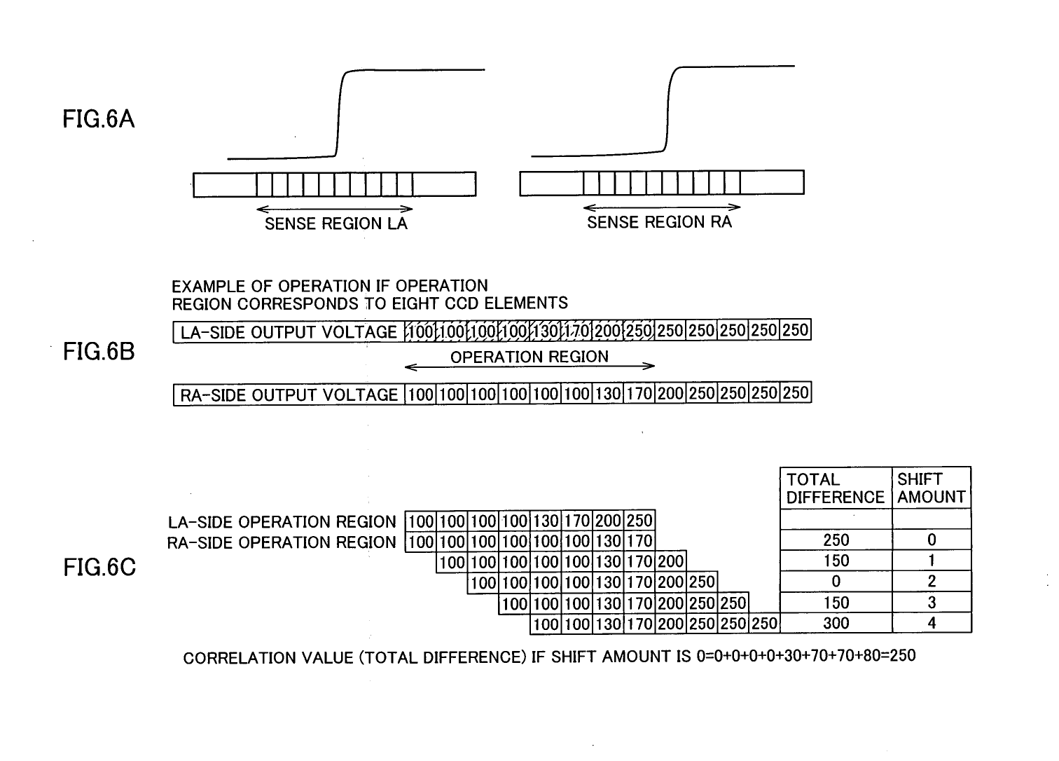

Referring to FIG. 6A, the output voltage waveforms in sense regions RA and LA and partial CCD elements in operation regions will be described.

As shown in FIG. 6A, a predetermined region in each of sense regions RA and LA is designated as a predetermined operation region, and can be used for calculation of phase difference ΔX.

FIG. 6B describes output voltages of the CCD elements in the predetermined operation regions of sense regions RA and LA of FIG. 6A.

As shown in FIG. 6B, the output voltages of the CCD elements in respective sense regions RA and LA are shown. By way of example, an example in which a region corresponding to eight CCD elements is designated as the operation region will be described.

FIG. 6C describes a correlation value between a total output voltage in sense region RA and that in sense region LA. A shift amount of the elements in sense region RA is set at 0, 1, 2, . . . , thereby sequentially shifting the operation region of sense region RA. The shift amount is calculated so as to minimize the correlation value (total difference) between the total output voltage in sense region RA and that in sense region LA, whereby phase difference ΔX can be calculated.

Specifically, if the shift amount of the elements in sense region RA is 0, the correlation value is 250. If the shift amount is 1, the correlation value is 150. If the shift amount is 2, the correlation value is 0. If the shift amount is 3, the correlation value is 150. If the shift amount is 4, the correlation value is 300.

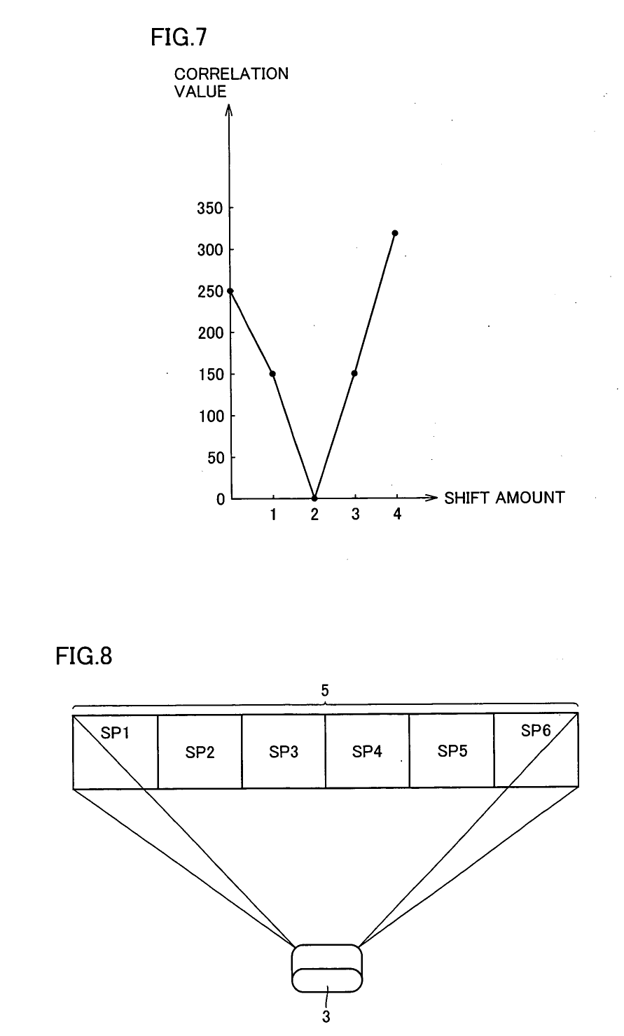

Referring to FIG. 7, a relationship between the correlation value and the shift amount described with reference to FIGS. 6A to 6C will be described.

As shown in FIG. 7, if the shift amount is 2, the minimum correlation value can be obtained. Namely, it is possible to calculate a minimum phase difference by as much as a length of shifting the elements by two. Since a length between the elements is known, phase difference ΔX can be calculated based on this shift amount and the known length between the elements. That is, length E to subject P can be calculated based on the above-described calculation. Since the calculated shift amount is based on the number of elements, an interpolation operation for accurately obtaining the image forming position on the element can further executed. Specifically, a shift amount corresponding to an actual minimum correlation value can be determined based on an inclination between the calculated shift amount by which the minimum correlation value has been obtained (this shift amount is hereinafter referred to as shift amount A) and a correlation value corresponding to a shift amount preceding shift amount A and an inclination between shift amount A and a correlation value corresponding to a shift amount following shift amount A.

Based on the above-described method, sensor 3 calculates length E to each of a plurality of preset points in the obstacle detection range. If obtained length E is shorter than a predetermined threshold, it is determined that sensor 3 react and that a target object can be detected.

The vacuum cleaner according to this embodiment of the present invention can ensure the wide obstacle detection range using a single passive sensor. While a plurality of active sensors need to be provided so as to ensure the same wide obstacle detection range, it suffices to use a single passive sensor according to the first embodiment of the present invention. Therefore, cost can be reduced and installation efficiency can be improved, as compared with the conventional techniques.

Obstacle detection executed by controller 2 according to the first embodiment of the present invention will now be described.

Referring to FIG. 8, an example of dividing obstacle detection range 5 into a plurality of sensor blocks according to this embodiment will be described.

FIG. 8 illustrates the instance of dividing the plural CCD elements into six sensor blocks SP according to this embodiment. In FIG. 8, obstacle detection range 5 is divided into sensor blocks SP1 to SP6. The length to the target object, described above, is measured in each sensor block SP.

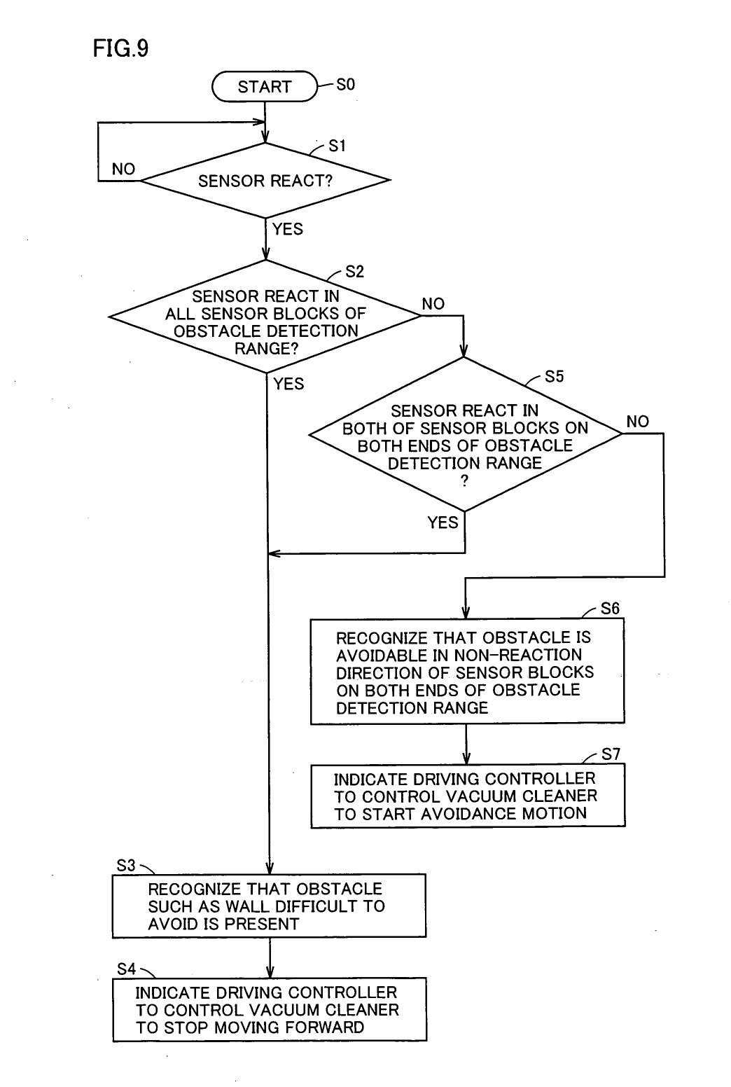

Referring to FIG. 9, an example in which an obstacle detection processing executed by controller 2 according to this embodiment will be described.

As shown in FIG. 9, the vacuum cleaner is activated and starts a cleaning operation (step S0). Controller 2 determines whether sensor 3 reacts (step S1). If sensor 3 does not react, controller 2 continues to execute step S1.

If sensor 3 reacts, the processing proceeds to step S2, in which controller 2 determines whether sensor 3 reacts in all sensor blocks SP1 to SP6 of obstacle detection range 5. If sensor 3 reacts in all sensor blocks SP1 to SP6 of obstacle detection range 5, sensor 3 recognizes that an obstacle such as a wall difficult to avoid is present (step S3). Controller 2 indicates driving controller 9 to control the vacuum cleaner to stop moving forward (step S4).

If controller 2 determines in step S2 that sensor 3 does not react in all sensor blocks SP1 to SP6 of obstacle detection range 5, the processing proceeds to step S5. In step S5, controller 2 determines whether sensor 3 reacts in both of sensor blocks SP1 and SP6 on both ends of obstacle detection range 5 (step S5).

If controller 2 determines in step S5 that sensor 3 reacts in both of sensor blocks SP1 and SP6 on both ends of obstacle detection range 5, the processing proceeds to step S3 in which controller 2 recognizes that the obstacle such as the wall difficult to avoid is present, and indicates driving controller 9 to control the vacuum cleaner to stop moving forward as described above (step S4).

On the other hand, if controller 2 determines that sensor 3 does not react in either of sensor blocks SP1 and SP6 on both ends of obstacle detection range 5, controller 2 recognizes the obstacle is avoidable in a non-reaction direction of sensor blocks SP1 and SP6 on both ends of obstacle detection range 5 (step S6). Controller 2 then indicates driving controller 9 to control the vacuum cleaner to start an avoidance motion in the non-reaction direction (step S7). The avoidance motion is a motion of the vacuum cleaner according to a program stored in a storage unit which is not shown. For example, the program can be set so that the vacuum cleaner moves in entire obstacle detection range 5 until sensor 3 reacts.

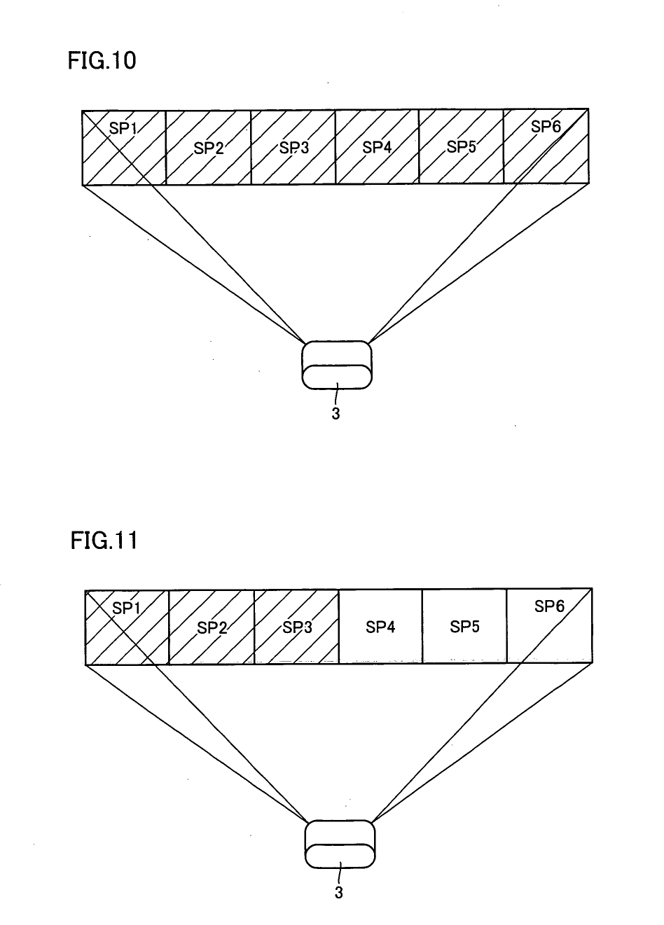

As shown in FIG. 10, if sensor 3 reacts in all of sensor blocks SP1 to SP6 of obstacle detection range 5, controller 2 recognizes that the obstacle such as the wall difficult to avoid is present (step S3), and indicates driving controller 9 to control the vacuum cleaner to stop moving forward (step S4).

As shown in FIG. 11, if sensor 3 does not react in all of sensor blocks SP1 to SP6 of obstacle detection range 5, controller 2 determines whether sensor 3 reacts in both of sensor blocks SP1 and SP6 on both ends of obstacle detection range 5 (step. S5). In the example of FIG. 11, since sensor 3 does not react in sensor block SP6, controller 2 recognizes that the obstacle is avoidable in a direction of sensor block SP6 (step S6). Controller 2 then indicates driving controller 9 to control the vacuum cleaner to start the avoidance motion in the direction of sensor block SP6 (step S7).

With the obstacle detection according to the first embodiment of the present invention, single passive sensor 3 can determine a shape of the obstacle, i.e., determine whether the obstacle is an obstacle such as a wall difficult to avoid or an avoidable obstacle.

### Modification of First Embodiment

In the first embodiment of the present invention, the obstacle detection method for detecting the obstacle or the like in front of the vacuum cleaner in the forward direction thereof using sensor 3 has been described. In a modification of the first embodiment, an obstacle detection method capable of detecting a wall or the like in a side surface direction will be described.

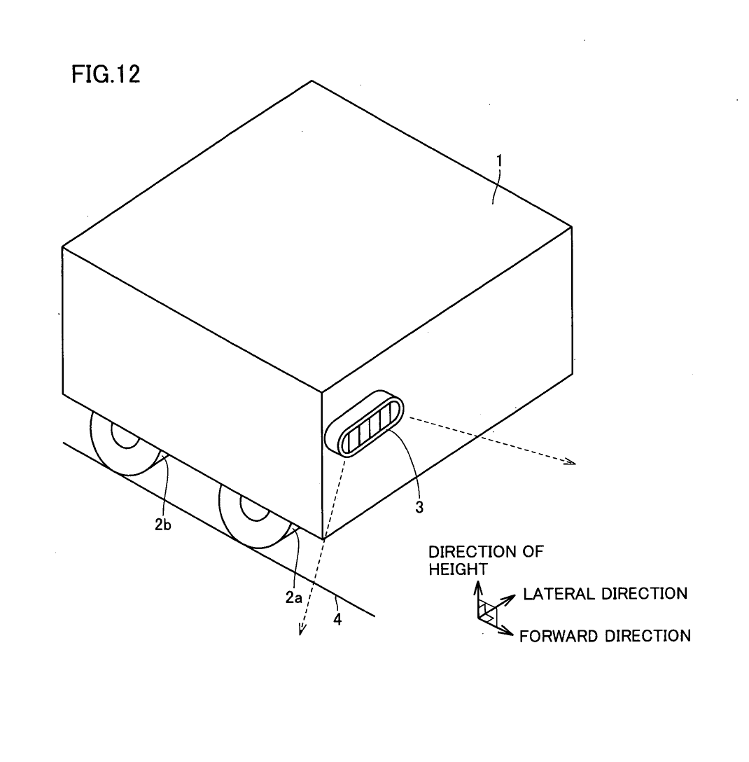

Referring to FIG. 12, a configuration of a self-traveling vacuum cleaner according to the modification of the first embodiment of the present invention differs from that of the vacuum cleaner according to the first embodiment of the present invention shown in FIG. 1 in that sensor 3 is moved to a side surface direction of main body 1. Since the other configuration is equal to that shown in FIG. 1, it will not be repeatedly described herein in detail.

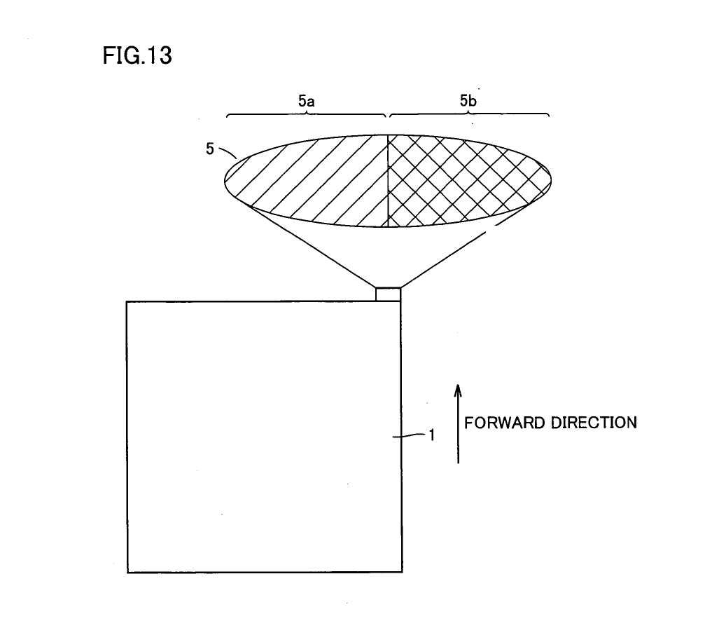

Referring to FIG. 13, obstacle detection range 5 of sensor 3 of the self-traveling vacuum cleaner according to the modification of the first embodiment of the present invention will be described.

As shown in FIG. 13, obstacle detection range 5 is divided into a sensor block 5a narrower than a main body width of the self-traveling vacuum cleaner, i.e., inward of a forward region of main body 1, and a sensor block 5b outward of the forward region of main body 1.

In the modification of the first embodiment of the present invention, an obstacle in front of the vacuum cleaner in the forward direction thereof is detected using sensor block 5a, and an obstacle outward of the main body width of the vacuum cleaner in the side surface direction thereof is detected using sensor block 5b.

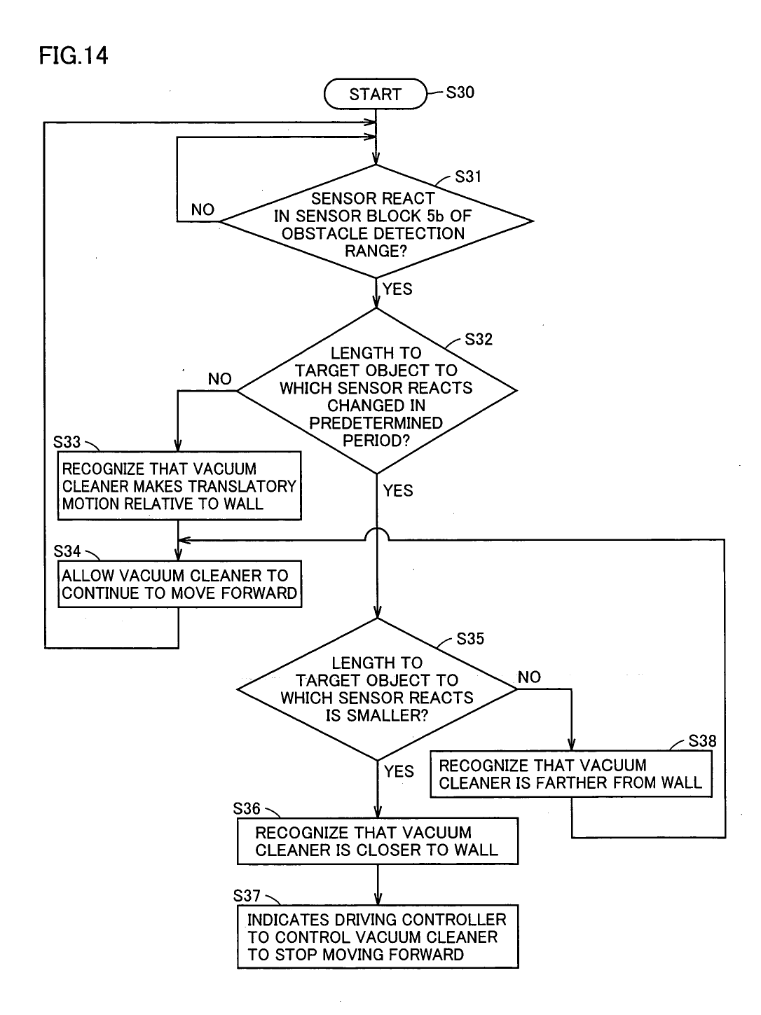

Referring to FIG. 14, an example in which an obstacle detection processing executed by controller 2 according to the modification of the first embodiment of the present invention will be described.

Similarly to the first embodiment, the vacuum cleaner is activated and starts a cleaner operation (step S30). Controller 2 determines whether sensor 3 reacts in sensor block 5b of obstacle detection range 5 (step S31). If sensor 3 does not react in sensor block 5b, controller 2 continues to execute step S31. If sensor 3 reacts in sensor block 5b, controller 2 determines whether a length to a target object to which sensor 3 reacts is changed in a predetermined period (step S32).

If controller 2 determines in step S32 that the length to the target object to which sensor 3 reacts is not changed in the predetermined period, controller 2 recognizes that the vacuum cleaner makes a translatory motion relative to a wall (step S33). The vacuum cleaner continues to move forward (step S34). Namely, controller 2 does not indicate driving controller 9 to control the vacuum cleaner to stop moving forward. The processing returns to first step S31.

If controller 2 determines in step S32 that the length to the target object to which sensor 3 reacts is changed in the predetermined period, controller 2 determines whether the length to the target object to which sensor 3 reacts is smaller (step S35).

If controller 2 determines in step S35 that the length to the target object to which sensor 3 reacts is shorter, controller 2 recognizes that the vacuum cleaner is closer to a wall (step S36). Controller 2 then indicates driving controller 9 to control the vacuum cleaner to stop moving forward (step S37).

If controller 2 determines in step S35 that the length to the target object to which sensor 3 reacts is not shorter, that is, the length is longer, controller 2 recognizes that the vacuum cleaner is farther from the wall (step S38). The processing then proceeds to step S34.

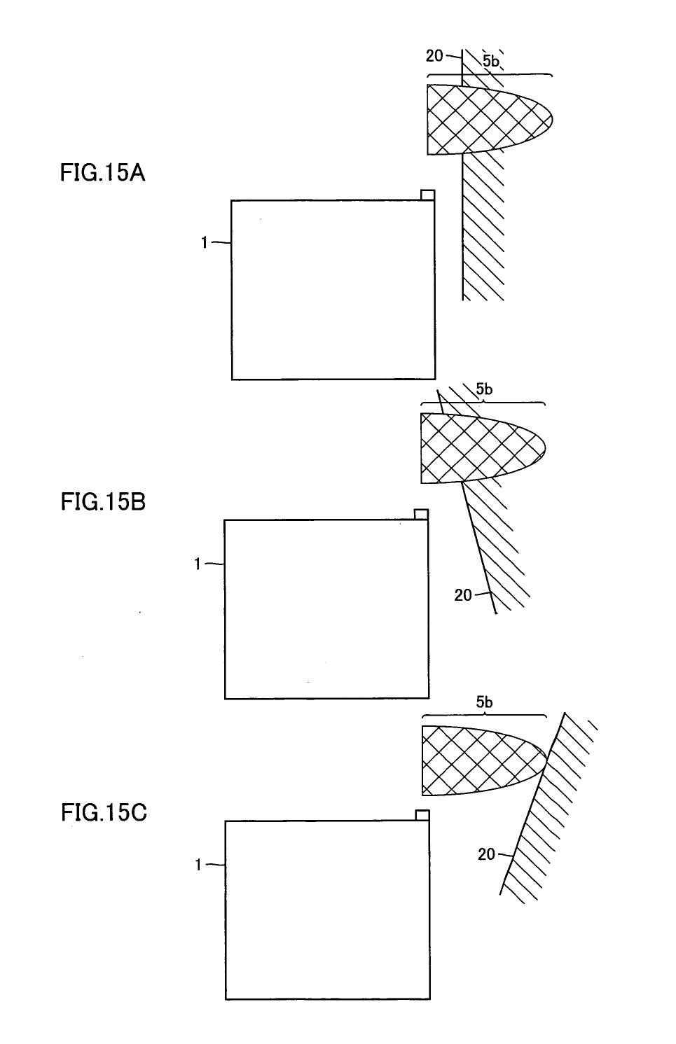

Referring to FIG. 15A, an example in which the vacuum cleaner makes a translatory motion relative to a wall 20 will be described.

In this case, in step S31 in the flowchart of FIG. 14, sensor 3 reacts in sensor block 5b of obstacle detection range 5, and the processing proceeds to the next step in which controller 2 determines whether the length to the target object to which sensor 3 reacts is changed in the predetermined period (step S32). In the example of FIG. 15A, since the length to the target object is not changed in the predetermined period, controller 2 recognizes that the vacuum cleaner makes a translatory motion relative to wall 20 (step S33). The processing proceeds to step S34 and then returns to first step S31.

Referring to FIG. 15B, an example in which the vacuum cleaner is closer to wall 20 will be described.

In this case, the processing proceeds to steps S31 and S32 in the flowchart of FIG. 14. In step S32, controller 2 determines whether the length to the target object to which sensor 3 reacts is changed in the predetermined period. Since controller determines in step S32 that the length to the target object to which sensor 3 reacts is changed in the predetermined period, the processing proceeds to next step S35. Controller determines whether the length to the target object to which sensor 3 reacts is shorter (step S35). Since controller determines in step S35 that the length to the target object to which sensor 3 reacts is smaller, controller 2 recognizes that the vacuum cleaner is closer to wall 20 (step S36). Controller 2 then indicates driving controller 9 to control the vacuum cleaner to stop moving forward (step S37).

Referring to FIG. 15C, an example in which the vacuum cleaner is farther from wall 20 will be described.

In this case, the processing proceeds to steps S31 and S32 in the flowchart of FIG. 15. In step S32, controller 2 determines whether the length to the target object to which sensor 3 reacts is changed in the predetermined period. Since controller determines in step S32 that the length to the target object to which sensor 3 reacts is changed in the predetermined period, the processing proceeds to next step S35. Controller determines whether the length to the target object to which sensor 3 reacts is shorter (step S35). Since controller determines in step S35 that the length to the target object to which sensor 3 reacts is not shorter, that is, the length is longer, controller 2 recognizes that the vacuum cleaner is farther from wall 20 (step S38). Controller 2 then indicates driving controller 9 to control the vacuum cleaner to continue to move forward (step S34).

As can be seen, with the obstacle detection according to the modification of the first embodiment of the present invention, it is possible to determine whether the vacuum cleaner makes a translatory motion relative to the wall, whether the vacuum cleaner is closer to the wall, or whether the vacuum cleaner is farther from the wall using sensor block 5b of obstacle detection range 5.

Further, it is possible to detect the obstacle in the forward direction of the vacuum cleaner using sensor block 5b of obstacle detection range. According to the conventional techniques, it is disadvantageously necessary to arrange sensors for the obstacle in the forward direction and that in the side surface direction of the vacuum cleaner, respectively, to detect these obstacles. With the configuration of the vacuum cleaner according to the modification of the first embodiment of the present invention, by contrast, the obstacles can be detected using the single passive sensor. Therefore, cost can be reduced and installation efficiency can be improved.

### Second Embodiment

In the first embodiment, the instances of detecting the obstacle in the forward direction and the obstacle such as the wall relative to which the vacuum cleaner makes a translatory motion have been described. In a second embodiment of the present invention, obstacle detection capable of detecting a stepped portion and an obstacle in the forward direction will be described.

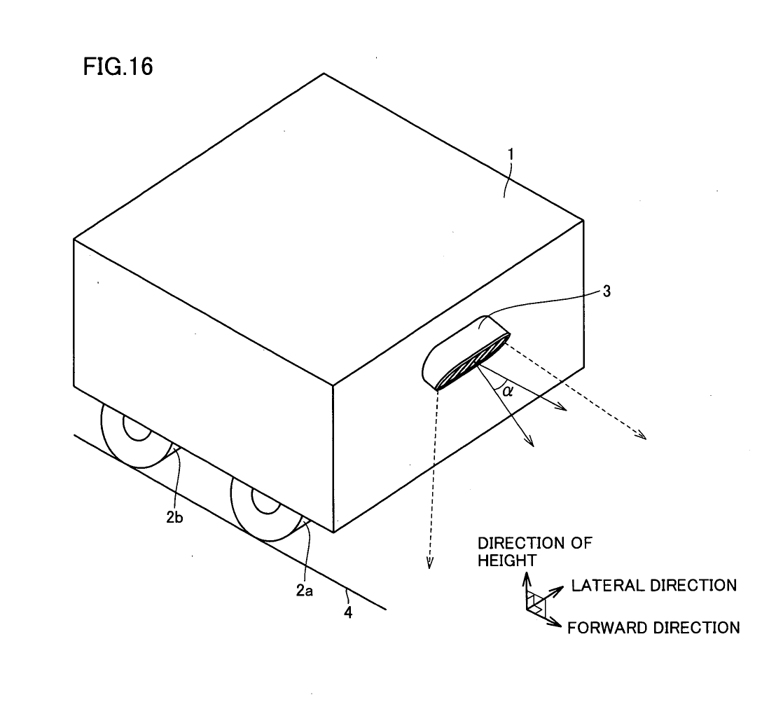

Referring to FIG. 16, a self-traveling vacuum cleaner according to the second embodiment of the present invention includes sensor 3 arranged to be turn downward so as to detect a cleaning target surface in a forward direction region. Specifically, sensor 3 is arranged laterally and to have a predetermined depression angle α with respect to a horizontal level in the forward direction.

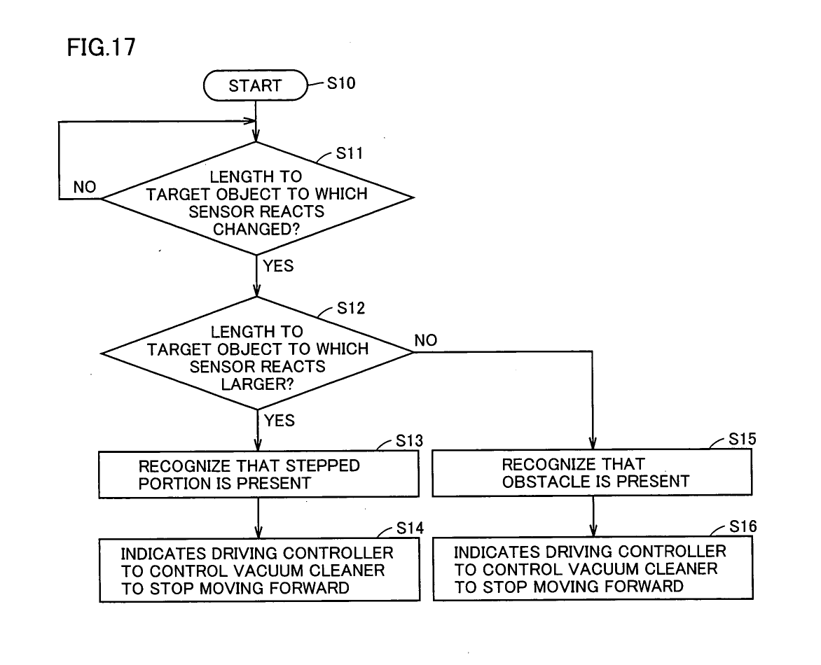

Referring to FIG. 17, the obstacle detection for detecting an obstacle such as a stepped portion according to the second embodiment of the present invention will be described.

As shown in FIG. 17, the vacuum cleaner is activated and starts a cleaning operation (step S10). Controller 2 then determines whether a length to a target object, which is the cleaning target surface in this embodiment, to which sensor 3 reacts is changed (step S11). If controller 2 determines that the length to the target object to which sensor 3 reacts is not changed, controller 2 continues to execute step S11.

If controller 2 determines that the length to the target object to which sensor 3 reacts is changed, the processing proceeds to step S12 in which controller 2 determines whether the length to the target object to which sensor 3 reacts is longer (step S12). If controller 2 determines in step S12 that the length to the target object to which sensor 3 reacts is longer, controller 2 recognize that a stepped portion is present (step S13). Controller 2 then indicates driving controller 9 to control the vacuum cleaner to stop moving forward (step S14).

If controller 2 determines in step S12 that the length to the target object to which sensor 3 reacts is not longer, that is, the length is shorter, controller 2 recognize that an obstacle is present (step S15). Controller 2 then indicates driving controller 9 to control the vacuum cleaner to stop moving forward (step S16).

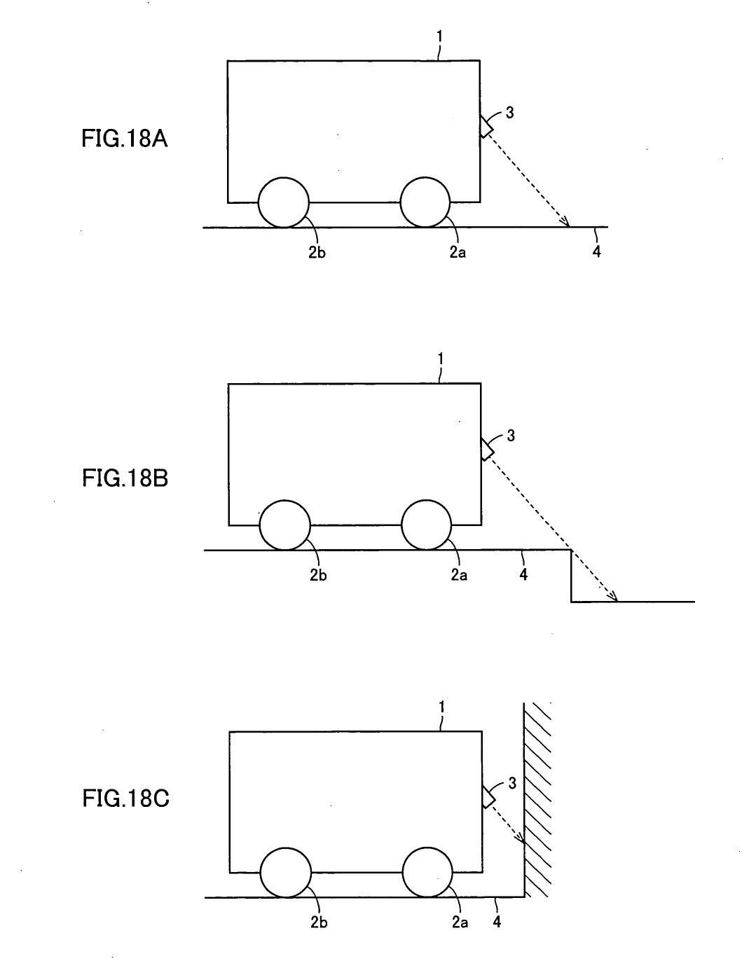

FIG. 18A illustrates a state in which sensor 3 is arranged to turn downward and measures the length to the cleaning target surface. In a normal operation, therefore, the length to the cleaning target surface from sensor 3 is a predetermined length and is not changed.

FIG. 18B describes an example in which the stepped portion that is the obstacle is present in the forward direction.

In the example of FIG. 18B, in step S11 in the flowchart of FIG. 17, controller 2 determines that the length to the target object to which sensor 3 reacts is changed. The processing proceeds to the next step in which controller 2 determines whether the length to the target object to which sensor 3 reacts is longer (step S12). In this example, since the length to the target object to which sensor 3 reacts is longer as shown in FIG. 18B, the processing proceeds to step S13 in which controller 2 recognize that the stepped portion is present (step S13). Controller 2 then indicates driving controller 9 to control the vacuum cleaner to stop moving forward (step S14).

FIG. 18C describes an example in which the obstacle is present in the forward direction.

In the example of FIG. 18C, in step S11 in the flowchart of FIG. 17, controller 2 determines that the length to the target object to which sensor 3 reacts is changed. The processing proceeds to the next step in which controller 2 determines whether the length to the target object to which sensor 3 reacts is longer (step S12). In this example, since the length to the target object to which sensor 3 reacts is not longer, that is, the length is shorter, the processing proceeds to step S15 in which controller 2 recognize that the obstacle is present (step S15). Controller 2 then indicates driving controller 9 to control the vacuum cleaner to stop moving forward (step S16).

As can be seen, with the obstacle detection according to the second embodiment of the present invention, the stepped portion and the obstacle in the forward direction can be detected. The obstacle detection according to the second embodiment of the present invention particularly enables obstacle detection in a wide range since the passive sensor having the predetermined angle of visibility is used.

### Third Embodiment

In the second embodiment, the obstacle detection for detecting the stepped portion and the like on the cleaning target surface has been described. In a third embodiment of the present invention, obstacle detection for detecting an obstacle above the main body of the vacuum cleaner will be described.

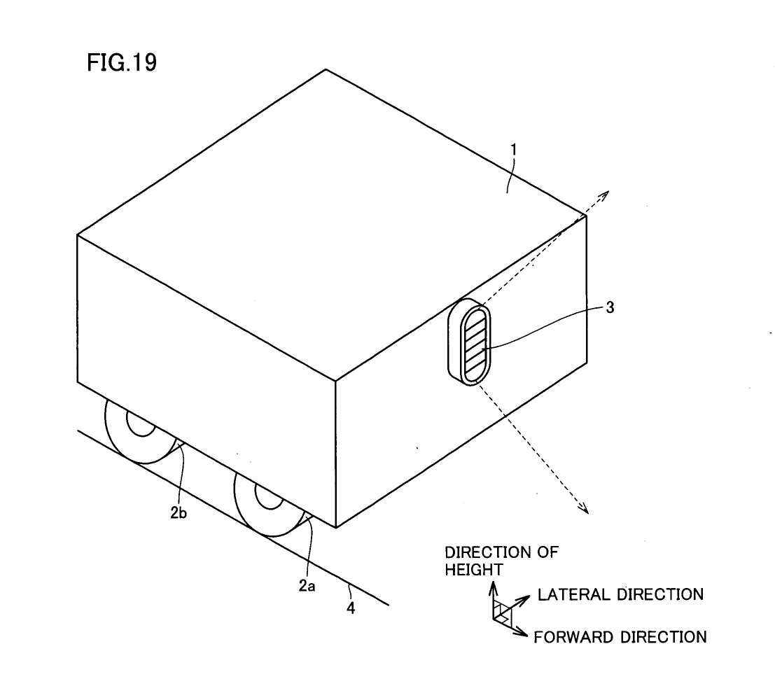

Referring to FIG. 19, a self-traveling vacuum cleaner according to the third embodiment of the present invention includes sensor 3 arranged in an upper portion, in the direction of height, on a front surface of the vacuum cleaner in the forward direction. Namely, sensor 3 is arranged to be able to detect a target object in an upper region than a height of cleaner main body 1 in the direction of height.

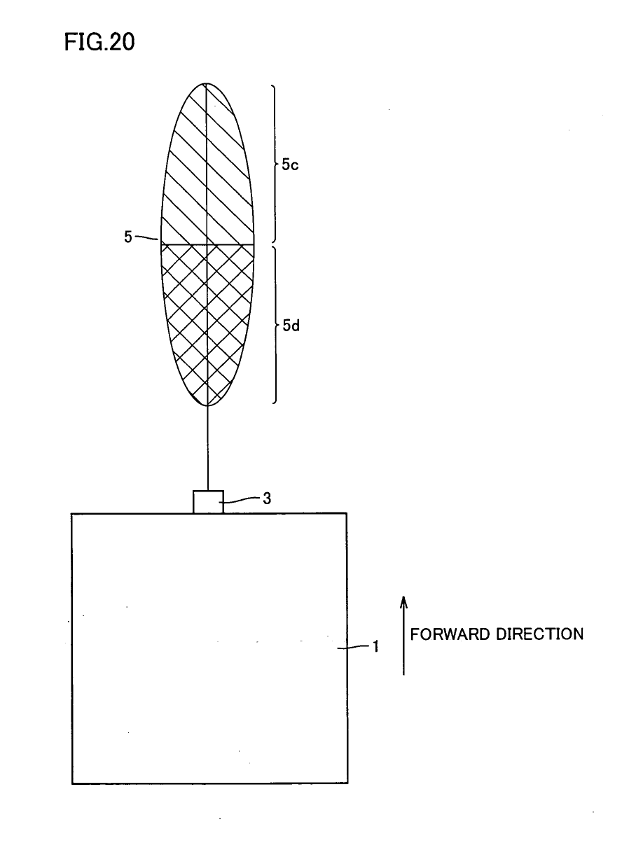

Referring to FIG. 20, obstacle detection range 5 of sensor 3 shown in FIG. 19 is divided into a sensor block 5c for detecting the upper region than the maximum height of main body 1, and a sensor block 5c for detecting a remaining lower region.

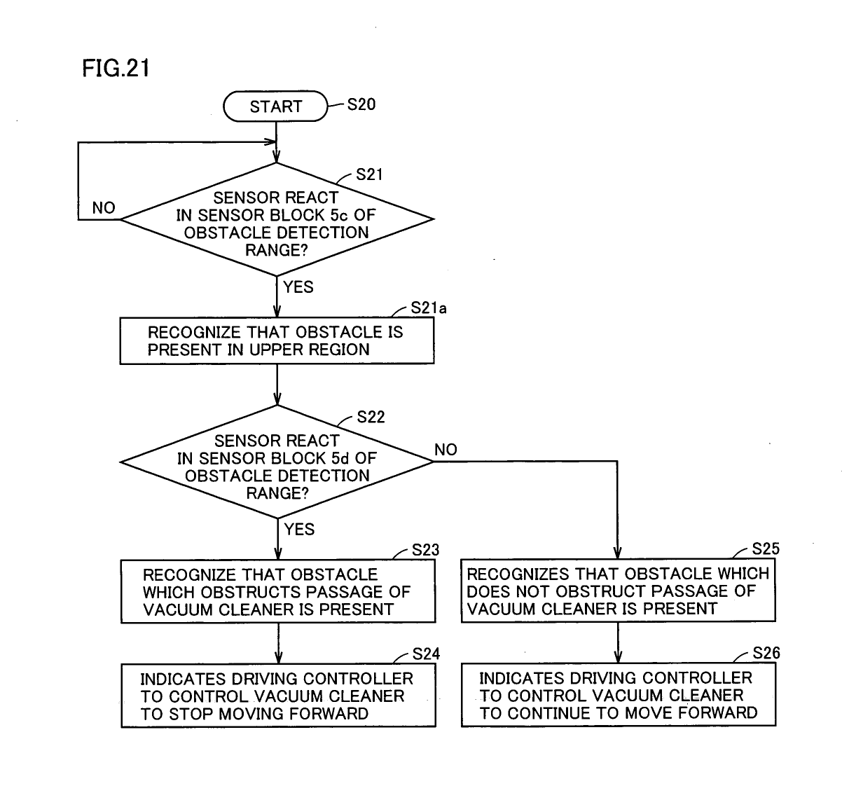

Referring to FIG. 21, obstacle detection for detecting an obstacle in the upper region than main body 1 of the vacuum cleaner according to the third embodiment of the present invention will be described.

As shown in FIG. 21, the vacuum cleaner is activated and starts a cleaning operation (step S20) similarly to the preceding embodiments. Controller 2 determines whether sensor 3 reacts in sensor block 5c of obstacle detection range 5 (step S21). If controller 2 determines in step S21 that sensor 3 reacts in sensor block 5c of obstacle detection range 5, controller 2 recognizes that an obstacle is present in the upper region than main body 1 (step S21a). Controller 2 then determines whether sensor 3 reacts in sensor block 5d of obstacle detection range 5 (step S22). If controller 2 determines in step S22 that sensor 3 reacts in sensor block 5d of obstacle detection range 5, controller 2 recognizes that the obstacle which obstructs the passage of the vacuum cleaner is present (step S23). Controller 2 then indicates driving controller 9 to control the vacuum cleaner to stop moving forward (step S24).

If controller 2 determines in step S22 that sensor 3 does not react in sensor block 5d of obstacle detection range 5, controller 2 recognizes that the obstacle which does not obstruct the passage of the vacuum cleaner is present (step S25). Controller 2 then indicates driving controller 9 to control the vacuum cleaner to continue to move forward (step S26).

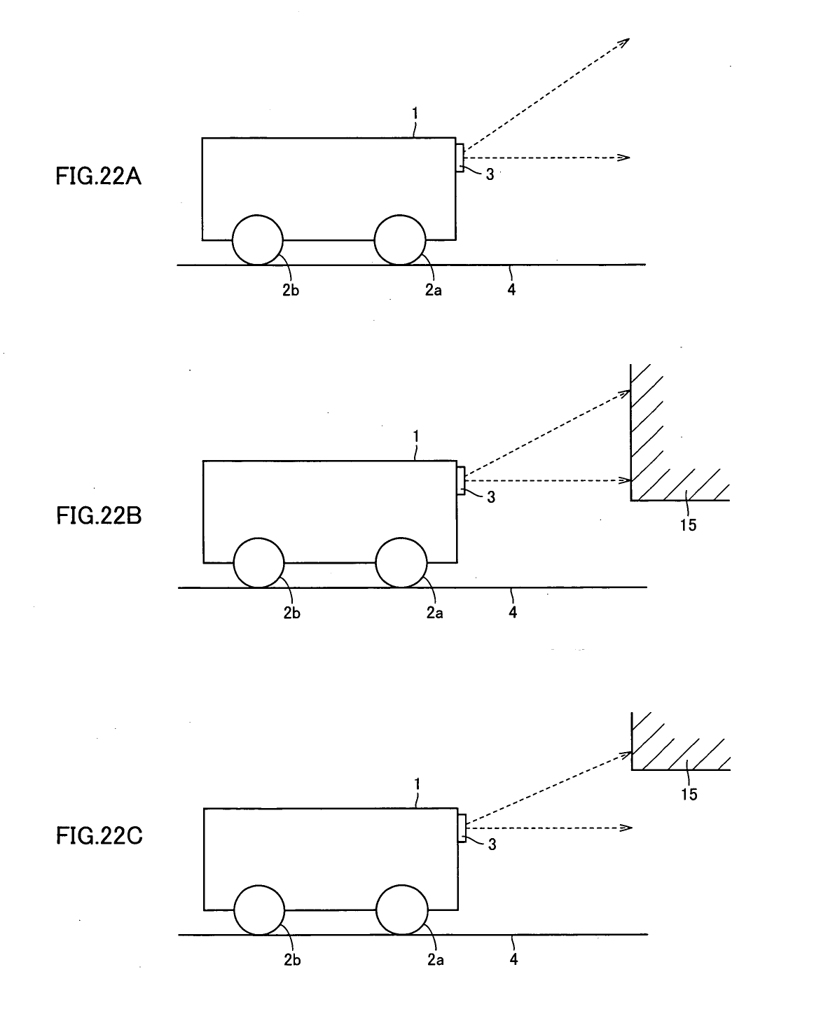

FIG. 22A illustrates a state in which sensor 3 is arranged on the self-traveling vacuum cleaner according to the third embodiment of the present invention and in which sensor 3 measures a length to a target object in the forward direction and a length to a target object in the upper region than main body 1. Specifically, as already described above, the target object in the upper region than the maximum height of main body 1 is detected using sensor block 5c, and the target object in the lower region thereof is detected using sensor block 5d.

Referring to FIG. 22B, an example in which the obstacle or the like which obstruct the passage of the vacuum cleaner is present in the upper region in the forward direction will be described.

In the example of FIG. 22B, in step S21 in the flowchart of FIG. 21, controller 2 determines that sensor 3 reacts in sensor block 5c of obstacle detection range 5. Therefore, controller 2 recognizes that an obstacle is present in the upper region (step S21a). The processing proceeds to step S22 in which controller 2 determines whether sensor 3 reacts in sensor block 5d of obstacle detection range 5 (step S22). In this example, since sensor 3 reacts in sensor block 5d of obstacle detection range 5, controller 2 recognizes that the obstacle which obstructs the passage of the vacuum cleaner is present (step S23). Controller 2 then indicates driving controller 9 to control the vacuum cleaner to stop moving forward (step S24).

Referring to FIG. 22C, an example in which the obstacle or the like which does not obstruct the passage of the vacuum cleaner is present in the upper region in the forward direction will be described.

In this example, since sensor 2 reacts in sensor block 5 in step S21 in the flowchart of FIG. 21, controller 2 recognizes that an obstacle is present in the upper region (step S21a). The processing proceeds to step S22 in which controller 2 determines whether sensor 3 reacts in sensor block 5d of obstacle detection range 5. In this example, since sensor 3 does not react in sensor block 5d of obstacle detection range 5, controller 2 recognizes that the obstacle which does not obstruct the passage of the vacuum cleaner is present (step S25). Controller 2 then indicates driving controller 9 to control the vacuum cleaner to continue to move forward (step S26).

The example of detecting the obstacle in the upper region than main body 1 has been described. An obstacle in the forward direction can be also detected using sensor block 5d of obstacle detection range 5.

As can be seen, with the obstacle detection of the self-traveling vacuum cleaner according to the third embodiment of the present invention, the obstacle in the upper region than the maximum height of main body 1 can be detected, and it can be determined whether the vacuum cleaner can pass or cannot pass. An efficient cleaning operation can be, therefore, performed.

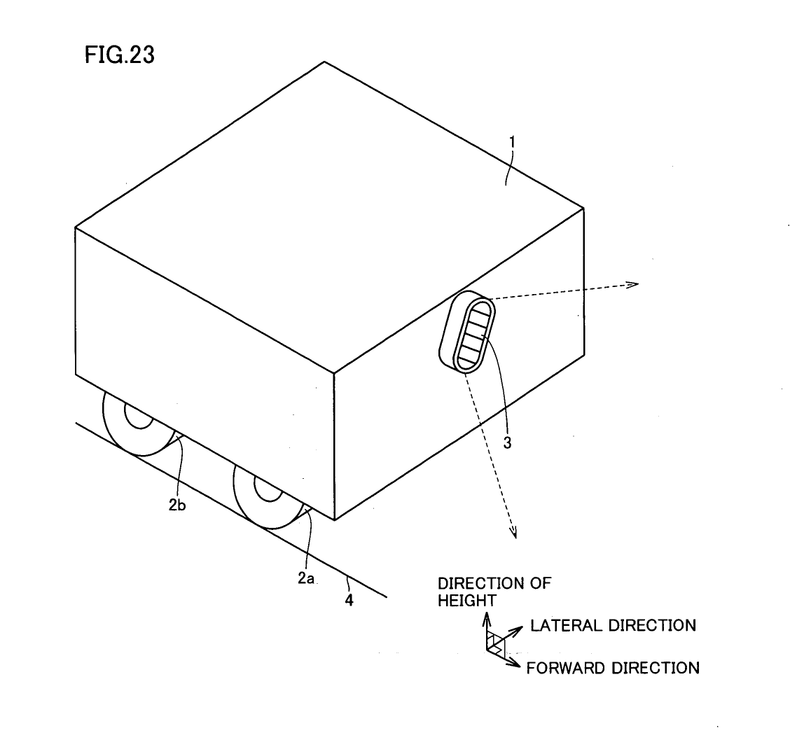

Referring to FIG. 23, another configuration of the self-traveling vacuum cleaner according to the third embodiment of the present invention differs from that shown in FIG. 19 in that sensor 3 is arranged not in the direction of height but aslant. Since the other configuration is equal to that shown in FIG. 19, it will not be repeatedly described herein in detail.

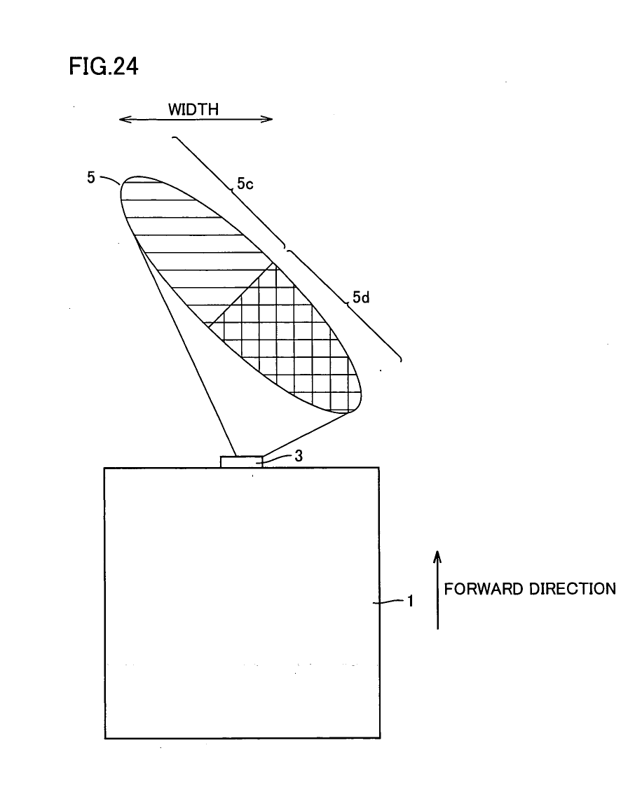

Referring to FIG. 24, obstacle detection range 5 of sensor 3 described with reference to FIG. 23 will be described.

As shown in FIG. 24, in this example, since sensor 3 is arranged not in the direction of height but aslant, obstacle detection range 5 is a range including not only a range in a height direction of main body 1 but also a range in a width direction of main body 1. Namely, sensor 3 has the angle of visibility with respect to not only the height direction but also the width direction of main body 1, so that sensor 3 can detect both a target object in the height direction and that in the width direction of main body 1.

Accordingly, when the obstacle detection according to the flowchart of FIG. 21 is executed, sensor 3 can detect the target object in the width direction of main body 1 of the vacuum cleaner described with reference to FIG. 19. It is, therefore, possible to detect the target object in the upper region in the width direction in a wider range.

### Modification of Third Embodiment

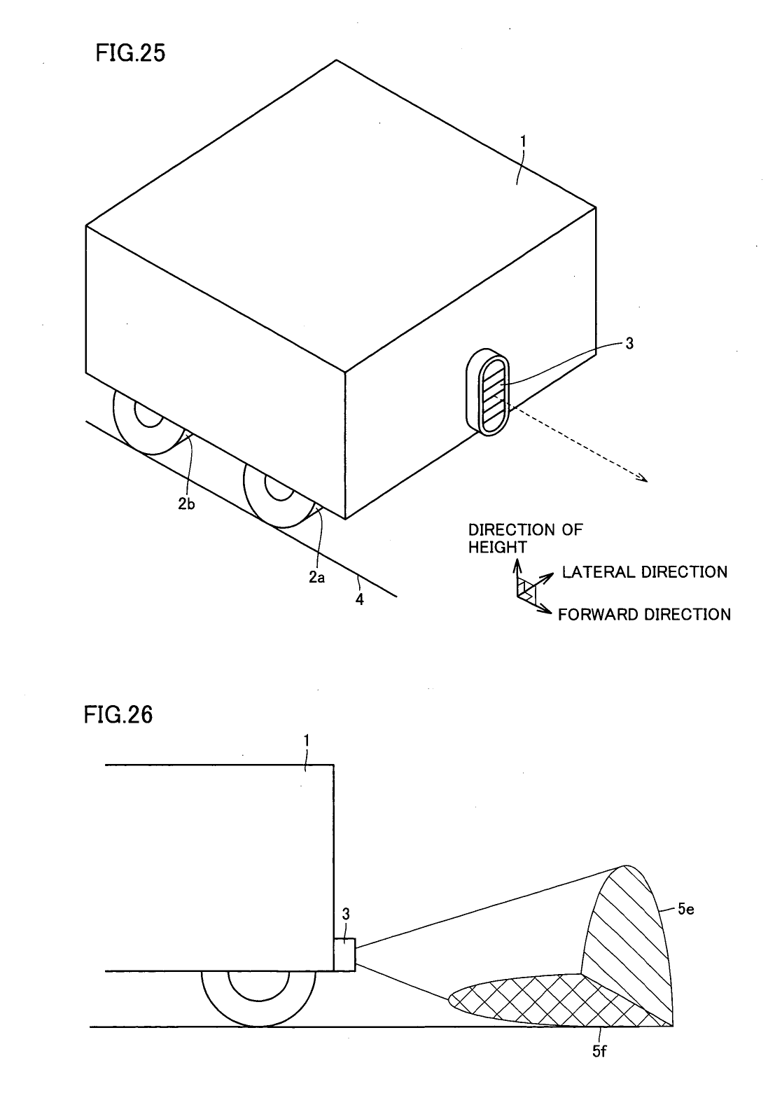

Referring to FIG. 25, a self-traveling vacuum cleaner according to a modification of the third embodiment of the present invention differs from the vacuum cleaner described with reference to FIG. 19 in that sensor 3 is provided in a lower portion on the front surface of main body 1 in the forward direction. Specifically, sensor 3 is arranged in the direction of height.

Referring to FIG. 26, obstacle detection range 5 of the vacuum cleaner shown in FIG. 25 according to the modification of the third embodiment of the present invention will be described.

As shown in FIG. 26, in this modification, obstacle detection range 5 is divided into a sensor block 5e for detecting a target object in the forward direction, and a sensor block 5f for detecting cleaning target surface 4.

By applying the obstacle detection method according to the flowchart of FIG. 17 to detection in sensor block 5f, the stepped portion or the like on cleaning target surface 4 can be detected.

By applying the obstacle detection method according to the flowchart of FIG. 17 to detection in sensor block 5e, the obstacle or the like in the forward direction can be detected.

According to the conventional techniques, it is disadvantageously necessary to arrange sensors for the obstacle in the forward direction and that in a direction of the cleaning target surface, respectively, to detect these obstacles. With the configuration of the vacuum cleaner according to the modification of the third embodiment of the present invention, by contrast, the obstacles can be detected using the single passive sensor. Therefore, cost can be reduced and installation efficiency can be improved.

### Fourth Embodiment

In the modification of the first embodiment of the present invention, the obstacle detection for detecting the target object such as the wall in the forward direction and that relative to which the vacuum cleaner makes a translatory motion, in the side surface direction has been described. In a fourth embodiment of the present invention, an example of detecting a stepped portion in the forward direction and a wall or the like relative to which the vacuum cleaner makes a translatory motion in the side surface direction will be described.

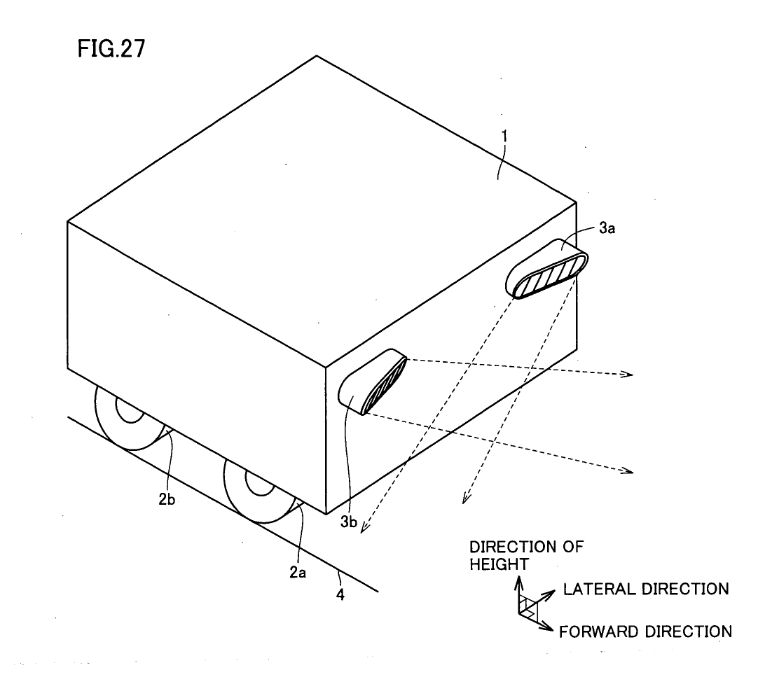

Referring to FIG. 27, a self-traveling vacuum cleaner according to the fourth embodiment of the present invention includes two sensors 3a and 3b on one end and the other end of a front surface of main body 1 in the forward direction, respectively. Specifically, sensor 3a is provided on one end of the front surface of main body 1, has a predetermined depression angle with respect to a horizontal level in the forward direction, and is arranged laterally to be shifted aslant by a predetermined angle from the horizontal level in the forward direction so as to face the other end of the front surface. Sensor 3b is provided on the other end of the front surface of main body 1, has a predetermined depression angle with respect to the horizontal level in the forward direction, and is arranged laterally to be shifted aslant by a predetermined angle from the horizontal level in the forward direction so as to face one end of the front surface. Further, two sensors 3a and 3b are arranged so that directions of fields of view of sensors 3a and 3b cross each other if viewed from an upper portion of main body 1.

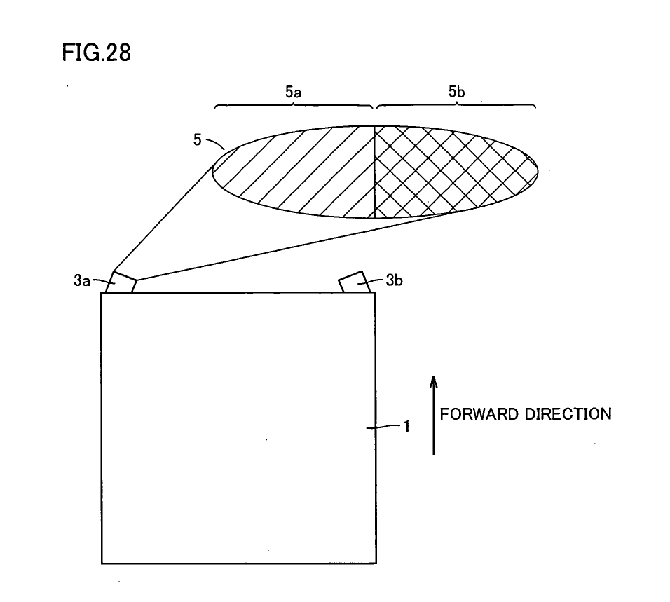

Referring to FIG. 28, obstacle detection range 5 in which sensor 3a shown in FIG. 27 detects a target object will be described.

As shown in FIG. 28, obstacle detection range 5 is divided into sensor block 5a narrower than the main body width of the self-traveling vacuum cleaner, i.e., inward of a forward region of main body 1 for detecting cleaning target surface 4, and sensor block 5b outward of the forward region of main body 1 for detecting a target object in the outward region of main body 1. Therefore, the obstacle detection for detecting the obstacle such as the stepped portion as described with reference to FIG. 17 is applied for detection in sensor block 5a. In addition, the obstacle detection for detecting the obstacle such as the wall relative to which the vacuum cleaner makes a translatory motion in the side surface direction as described with reference to FIG. 14 is applied for detection in sensor block 5b.

According to the conventional techniques, it is disadvantageously necessary to arrange sensors for the obstacle such as the stepped portion in the direction of the cleaning target surface and the obstacle such as the wall relative to which the vacuum cleaner makes a translatory motion in the side surface direction, respectively, to detect these obstacles. With the configuration of the vacuum cleaner according to the fourth embodiment of the present invention, by contrast, the obstacles can be detected using the single passive sensor. Therefore, cost can be reduced and installation efficiency can be improved.

Moreover, according to the fourth embodiment of the present invention, sensor 3a is provided on one end of the front surface of main body 1, has the predetermined depression angle with respect to the horizontal level in the forward direction, and is arranged to face the other end of the front surface. While a sense reaction of a sensor generally tends to be deteriorated at a close range, the configuration of the vacuum cleaner in this embodiment can secure a sufficient length from sensor 3a to obstacle detection range 4 and enables sufficiently highly accurate detection.

Although the present invention has been described and illustrated in detail, it is clearly understood that the same is by way of illustration and example only and is not to be taken by way of limitation, the spirit and scope of the present invention being limited only by the terms of the appended claims.

1. A self-traveling vacuum cleaner comprising:
a driving unit that moves a main body relative to a desired direction;
a sensor that receives a reflected light of a target object at a length within a certain length range at a predetermined angle of visibility, and that measures the length to said target object based on a phase difference of the received reflected light of said target object; and
a controller that calculates the length to said target object and that controls said driving unit based on a measurement result of said sensor, wherein
said sensor includes a first cell region and a second cell region for measuring a quantity of said received reflected light,
said controller calculates the length to said target object based on a relative difference of a measurement result obtained in the first cell region to a measurement result obtained in the second cell region,
said sensor is arranged to measure the target object in a lateral direction of a surface perpendicular to a forward direction, at said predetermined angle of visibility,
an obstacle detection range having said predetermined angle of visibility of said sensor is divided into a plurality of regions along said lateral direction,
said controller measures the length to said target object in each of said divided regions, and indicates said driving unit to stop the self-traveling vacuum cleaner if the length to said target object is equal to or smaller than a predetermined length in all of the divided regions of the obstacle detection range of said sensor, and
said sensor includes a plurality of CCD elements arranged on a line.

2. A self-traveling vacuum cleaner comprising:
a driving unit that moves a main body relative to a desired direction;
a sensor that receives a reflected light of a target object at a length within a certain length range at a predetermined angle of visibility, and that measures the length to said target object based on a phase difference of the received reflected light of said target object; and
a controller that calculates the length to said target object and that controls said driving unit based on a measurement result of said sensor.

3. The self-traveling vacuum cleaner according to claim 2, wherein
said sensor includes a first cell region and a second cell region for measuring a quantity of said received reflected light, and
said controller calculates the length to said target object based on a relative difference of a measurement result obtained in the first cell region to a measurement result obtained in the second cell region.

4. The self-traveling vacuum cleaner according to claim 2, wherein
said sensor is arranged to measure the target object in a lateral direction of a surface perpendicular to a forward direction, at said predetermined angle of visibility,
an obstacle detection range having said predetermined angle of visibility of said sensor is divided into a plurality of regions along said lateral direction, and
said controller measures the length to said target object in each of said plurality of regions, and indicates said driving unit to stop the self-traveling vacuum cleaner if the length to said target object is equal to or smaller than a predetermined length in all of the plurality of regions of the obstacle detection range of said sensor.

5. The self-traveling vacuum cleaner according to claim 2, wherein
said sensor is arranged to measure the target object in a lateral direction of a surface perpendicular to a forward direction, at said predetermined angle of visibility,
an obstacle detection range having said predetermined angle of visibility of said sensor is divided into a plurality of regions along said lateral direction, and
said controller measures the length to said target object in each of said plurality of regions, indicates, if the length to said target object is equal to or smaller than a predetermined length in the plurality of regions on both ends of the obstacle detection range of said sensor, respectively, said driving unit to stop the self-traveling vacuum cleaner, and indicates, if the length to said target object is equal to or smaller than the predetermined length in at least one of said regions on the both ends of the obstacle detection range, said driving unit to start an avoidance motion of avoiding toward the other region out of said regions on the both ends of the obstacle detection range.

6. The self-traveling vacuum cleaner according to claim 2, wherein
said sensor includes a plurality of CCD elements arranged on a line.

7. The self-traveling vacuum cleaner according to claim 2, wherein
said sensor is arranged to measure the target object in a lateral direction of a surface perpendicular to a forward direction, at said predetermined angle of visibility,
an obstacle detection range having said predetermined angle of visibility of said sensor is divided into a first region in a direction of a forward region of the main body and a second region outward of the forward region of the main body, and
said controller measures the length to the target object in said second region, and indicates said driving unit to stop the self-traveling vacuum cleaner if the length to said target object in said second region is changed in a predetermined period.

8. The self-traveling vacuum cleaner according to claim 7, wherein
said controller measures the length to the target object in said first region, and indicates said driving unit to stop the self-traveling vacuum cleaner if the length to said target object in said first region is equal to or smaller than a predetermined length.

9. The self-traveling vacuum cleaner according to claim 2, wherein.
said sensor is arranged to measure a length to a cleaning target surface in a region in a forward direction, and
said controller measures the length to the cleaning target surface in said region in the forward direction, and indicates said driving unit to stop the self-traveling vacuum cleaner if the length to said cleaning target surface is changed from the certain length.

10. The self-traveling vacuum cleaner according to claim 9, wherein
said controller determines that a stepped portion is present if the length to said target object is larger than said certain length.

11. The self-traveling vacuum cleaner according to claim 9, wherein
said controller determines that an obstacle is present if the length to said target object is smaller than said certain length.

12. The self-traveling vacuum cleaner according to claim 2, wherein
said sensor is arranged to measure a cleaning target surface in a direction of a forward region of the main body and the target object outward of the forward region of the main body, at said predetermined angle of visibility,
an obstacle detection range having said predetermined angle of visibility of said sensor is divided into a first region inward of the forward region of the main body and a second region outward of the forward region of the main body, and
said controller measures the length to the target object in said second region, and indicates said driving unit to stop the self-traveling vacuum cleaner if the length to said target object in said second region is changed in a predetermined period and is smaller than said certain length.

13. The self-traveling vacuum cleaner according to claim 12, wherein
said controller measures a length to the cleaning target surface in said first region, and indicates said driving unit to stop the self-traveling vacuum cleaner if the length to said cleaning target surface in said first region is changed.

14. The self-traveling vacuum cleaner according to claim 12, wherein
said sensor is provided on one end of the main body in a lateral direction of the main body, has a predetermined depression angle with respect to a horizontal level in the forward direction, and is arranged laterally to be shifted by a predetermined angle from the horizontal level in the forward direction so as to face the other end of the main body in the forward direction.

15. The self-traveling vacuum cleaner according to claim 2, wherein
said sensor is arranged to measure the target object present in a direction of height of a surface perpendicular to a forward direction, at said predetermined angle of visibility,
an obstacle detection range having said predetermined angle of visibility of said sensor is divided into a first region for detecting an upper region than a maximum height of the main body in the direction of height and a second region for detecting a lower region than the maximum height of the main body in the direction of height, and
said controller measures the length to the target object in each of said first region and said second region, indicates said driving unit to stop the self-traveling vacuum cleaner if the length to said target object in said first region of the obstacle detection range of said sensor is equal to or smaller than a predetermined length and the length to said target object in said second region is equal to or smaller than the predetermined length, and fails to indicate said driving unit to stop the self-traveling vacuum cleaner if the length to said target object in said first region is equal to or smaller than the predetermined length and the length to said target object in said second region is not equal to or smaller than the predetermined length.

16. The self-traveling vacuum cleaner according to claim 2, wherein
said sensor is arranged aslant so as to measure the target object in each of a direction of height and a lateral direction of a surface perpendicular to a forward direction, at said predetermined angle of visibility,
an obstacle detection range having said predetermined angle of visibility of said sensor is divided into a first region for detecting an upper region than a maximum height of the main body in the direction of height and a second region for detecting a lower region than the maximum height of the main body in the direction of height, and
said controller measures the length to the target object in each of said first region and said second region, indicates said driving unit to stop the self-traveling vacuum cleaner if the length to said target object in said first region of the obstacle detection range of said sensor is equal to or smaller than the predetermined length and the length to said target object in said second region is equal to or smaller than the predetermined length, and fails to indicate said driving unit to stop the self-traveling vacuum cleaner if the length to said target object in said first region is equal to or smaller than the predetermined length and the length to said target object in said second region is not equal to or smaller than the predetermined length.

17. The self-traveling vacuum cleaner according to claim 2, wherein
said sensor is arranged to measure a cleaning target surface in a region in a forward direction of the main body and the target object in the forward direction, at said predetermined angle of visibility,
an obstacle detection range having said predetermined angle of visibility of said sensor is divided into a first region in the forward direction of the main body and a second region in a direction of the cleaning target surface in the region of the main body in the forward direction, and
said controller measures a length to the cleaning target surface in said second region, indicates said driving unit to stop the self-traveling vacuum cleaner if the length to said cleaning target surface in said second region is changed.

18. The self-traveling vacuum cleaner according to claim 17, wherein
said controller measures the length to the target object in the forward direction in said first region, and indicates said driving unit to stop the self-traveling vacuum cleaner if the length to said cleaning target surface in said first region is equal to a smaller than a predetermined length.
